(19) United States
(12) Patent Application Publication
(10) Pub. No.: US 2026/0153483 A1
(43) Pub. Date: Jun. 4, 2026

(54) A SYSTEM AND METHOD FOR ULTRASOUND IMAGING USING ARBITRARY VIRTUAL ARRAY SOURCES OF APERTURE EXCITATION

(71) Applicant: INDIAN INSTITUTE OF TECHNOLOGY MADRAS (IIT MADRAS), Tamil Nadu Chennai (IN)

(72) Inventors: Thulsiram GANTALA, Tamil Nadu Chennai (IN); Krishnan BALASUBRAMANIAN, Tamil Nadu Chennai (IN)

(73) Assignee: INDIAN INSTITUTE OF TECHNOLOGY MADRAS (IIT MADRAS), (omitted)

(21) Appl. No.: 19/122,899

(22) PCT Filed: May 23, 2023
(86) PCT No.: PCT/IN2023/050487

§ 371 Date: Apr. 21, 2025

(30) Foreign Application Priority Data
Oct. 21, 2022 (IN) 202241060172

(51) Int. Cl. G01N 29/22; G01N 29/06; G01N 29/26; G01N 29/32

(52) U.S. Cl. CPC G01N 29/221; G01N 29/0645; G01N 29/262; G01N 29/32

(57) ABSTRACT

The present invention discloses a system (100) and method (1200) for ultrasound imaging using arbitrary virtual array sources of aperture excitation. The system (100) comprises at least one user device (102), an imaging device (104), a probe module (106), a sample module (108), a communication network (110) and at least one server (112). The user device (102) is configured to accept input data from the user. The imaging device (104) designed to monitor input data from the user interface and control the functioning of the PAUT probe. The probe module (106) triggers multiple transducer elements based on the input data to generate a wave pattern, where the wave propagates into the sample module (108) for non-destructive testing. The received wave is processed by the imaging device (104) to convert the analogue signal to digital before generating and displaying an ultrasound image of the sample.

### FIELD OF INVENTION

The field of invention generally relates to ultrasound imaging. More specifically, it relates to a system and method for ultrasound imaging using arbitrary virtual array sources of aperture excitation to enhance the image resolution and reduce the imaging processing time by creating beam forming at random virtual source locations.

### BACKGROUND

Non-destructive testing (NDT) is widely used to evaluate the properties of a material or system without causing damage. Ultrasound phased array (PA) imaging is the most widely accepted technique in non-destructive evaluation (NDE) applications for its ability to focus deeper and generate higher resolution imaging.

Typically, in the phased array (PA) technique, multiple transducer elements are arranged in a linear array and have the flexibility to create a beam forming within a material by activating each transducer element independently by predefined focal law. Beamforming or spatial filtering is a signal processing technique used in phased arrays for directional signal transmission or reception. The phased array (PA) has significant advantages over the traditional ultrasound techniques, such as (a) high-volume coverage and (b) beam focusing and steering can be achieved through electronic control without the mechanical movement of the transducer to generate B-scan imaging. A higher resolution imaging can be obtained either by performing ultrasound beam focusing during the experimentation, by altering the time delay, or by virtually focusing on each image pixel during the post-processing.

The Total Focusing Method (TFM) is an advanced image reconstruction algorithm to produce a fully focused image. The TFM is implemented on the Full Matrix Capture (FMC) time-domain A-scan signals. In FMC, each element in a linear array is excited in sequence, and then all the elements in the transducer array are used to receive the reflected signals. The image generated by using FMC-TFM shows lesser background noise and a better signal-to-noise ratio (SNR) for the defects present in the sample.

However, performing inspection using the FMC-TFM technique is overburdening, as it requires more extensive data recording during experimentation and takes significant computational time to process the image. Thus, the FMC-TFM method hinders the widespread of being a practical inspection technique. Furthermore, this limitation can be overcome in the following ways, (1) the TFM algorithm must be implemented using graphical processing units (GPU) for parallel calculations to reduce computational time. (2) Redundancy in the FMC recorded dataset can be eliminated by selecting an appropriate optimizing technique, improving the imaging quality, and reducing the processing time. Whereas in the FMC-TFM technique, the transmitted energy into the medium is limited because the single element is triggered at a time, which often leads to the poor SNR of the TFM image, especially while imaging for deeper depth.

Furthermore, to improve the transmitted ultrasound energy into the medium, a couple of transducer elements are grouped to form an active aperture and triggered with predefined focal law to create a beam profile. Further, an ultrasound beam will diverge from a point or converge into a point called the virtual source, which can occur above or below the transducer. Over the past decade, researchers proposed different techniques based on the focal laws to create the virtual source above or below the transducer. The reflected A-scan signals are received either using a single element or by all the elements to form an image. In the virtual source aperture (VSA) technique, different scanning strategies are extended, such as single, multiple, and angular virtual source positions to create the FMC data. The TFM algorithm is implemented on the received FMC data to form an image. The TFM images generated using FMC-TFM and the VSA technique shows additional imaging artifacts, which are misleading in interpreting the information in an image. These imaging artifacts in the FMC-TFM and VSA techniques are expected because all the transducer array elements are in the same phase during the TFM image reconstruction. In the FMC-TFM technique, the position of each element in a transducer array is linearly positioned. In the VSA technique, the multiple virtual sources lie in a constant focal depth plane from the transducer position.

Currently, existing systems do not succeed in overcoming the imaging artifacts.

To overcome these imaging artifacts, some of the existing systems have adopted suitable optimization techniques to select the active element in the transducer array to transmit the ultrasound into the medium. A recent study reports the extracting phase characteristic from the received A-scan signals to multiply TFM images during post processing. As a result, image resolution is partially enhanced by reducing the background noise.

Other existing systems have tried to address this problem. However, their scope was limited to high TFM imaging computational time which overburdens the process.

Further, in the existing systems data acquisition, data storage and analysis are tedious.

Thus, in light of the above discussion, it is implied that there is a need for a system and method for ultrasound imaging technique based on the phased array excitation to create the beam forming at random virtual source positions with predefined delay laws, which is reliable and does not suffer from the problems discussed above.

### OBJECT OF INVENTION

The principal object of this invention is to provide a system and method for ultrasound imaging using arbitrary virtual array sources of aperture excitation to enhance the image resolution and reduce the imaging processing time by creating beam forming at random virtual source locations.

A further object of the invention is to provide a system and method that enables increased energy transmission by activating a group of elements in the phased array transducer by employing a computed predetermined focal law for each arbitrary virtual source position.

Another object of the invention is to calculate a position of virtual sources using the Poisson distribution function.

A further object of the invention is to reduce inspection time by triggering fewer excitations, eventually reducing the number of A-scan signals to acquire, thus reducing imaging processing time.

Another object of the invention is to provide increased SNR of the received A-scans to improve the sensitivity of the deeper structural flaws.

A further object of the invention is to improve defect resolution by permitting a wider examination angle.

Another object of the invention is to reduce image artifacts near defects by establishing a constructive interference phenomenon of the defect signals and reduces background noise by forming a destructive interference phenomenon of the noise signals.

A further object of the invention is to manufacture the pulse-receiver device in a small-footprint, inexpensive manner and by using an image algorithm and scanning technique to inspect the structure.

### BRIEF DESCRIPTION OF FIGURES

This invention is illustrated in the accompanying drawings, throughout which, like reference letters indicate corresponding parts in the various figures.

The embodiments herein will be better understood from the following description with reference to the drawings, in which:

FIG. 1 illustrates details of a system for ultrasound imaging using arbitrary virtual array sources of aperture (AVASA) excitation, in accordance with an embodiment of the present disclosure;

FIG. 2 illustrates a block diagram depicting working mechanics of multiple units of ultrasound imaging system using arbitrary virtual array sources of aperture (AVASA) excitation, in accordance with an embodiment of the present disclosure;

FIG. 3 illustrates schematic block diagram of the experimental setup: inspecting test samples using imaging device, in accordance with an embodiment of the present disclosure;

FIG. 4 illustrates experimentally obtained TFM images of side-drilled holes (SDHs) test specimen 1 with various virtual sources of the AVASA technique in comparison with VASA and FMC-TFM, in accordance with an embodiment of the present disclosure;

FIG. 5 illustrates quantitative evaluation for the test specimen 1, in accordance with an embodiment of the present disclosure;

FIG. 6 illustrates AVASA images generated with the varying virtual sources are compared with VASA and FMC-TFM for test specimen 2, in accordance with an embodiment of the present disclosure;

FIG. 7 illustrates quantitative evaluation for the test specimen 2, in accordance with an embodiment of the present disclosure;

FIG. 8 illustrates the experimental results of the TFM images with various virtual sources and FMC-TFM for test specimen 3, in accordance with an embodiment of the present disclosure;

FIG. 9 illustrates quantitative evaluation for the test specimen 3, in accordance with an embodiment of the present disclosure;

FIG. 10 illustrates images generated using the TFM algorithm during post processing with FMC-TFM, VASA, and AVASA techniques with various virtual sources for ‘Y’ shaped crack, in accordance with an embodiment of the present disclosure;

FIG. 11 illustrates experimental results of the TFM images with various virtual sources of the VASA and AVASA and FMC-TFM for inclined ‘PI’ shaped crack, in accordance with an embodiment of the present disclosure; and

FIG. 12 illustrates a flowchart depicting the method for ultrasound imaging using arbitrary virtual array sources of aperture (AVASA) excitation, in accordance with an embodiment of the present disclosure.

### STATEMENT OF INVENTION

The present invention discloses a system and method for an advanced phased array-based ultrasound imaging technique to improve resolution and reduce the image processing time with limited experimental measurements by forming the converging beam at the arbitrary virtual array sources position.

The system comprises a user device, an imaging device, a probe module, a sample module, a communication network and a server. The imaging device comprises a data acquisition and control module, pulse delay module, and a multiplexer module. The server comprises a processing module, memory module, and a communication module.

A group of transducer elements are grouped to form the active aperture and triggered with predefined focal law to create the beam profile for transmitting the ultrasound energy into the medium. In this process, the ultrasound beam will diverge from a point or converges into a point called the virtual source, which can occur above or below the transducer. This method consists of multiple virtual sources and is placed below the transducer array. The location of each virtual source is determined using the Poisson distribution.

All the active aperture elements are excited with delay law information to create the ultrasound beam in the medium sequentially. The reflected wave is recorded using all the transducers in the array to create the full matrix capture data. The total focusing method algorithm is implemented to generate an image.

The method generates an image with fewer excitations of the virtual sources, which reduces the inspection time. Eventually, it reduces the number of A-scan signals to acquire, thus reducing imaging processing time. The method minimizes the imaging artifacts near defects by forming the constructive interference phenomenon of the defect signals and decreasing the background noise by creating the destructive interference of the noise signals. Hence, the artifacts around the defects are eliminated because the virtual source positions are randomly located and not in the same phased.

### DETAILED DESCRIPTION

The embodiments herein and the various features and advantageous details thereof are explained more fully with reference to the non-limiting embodiments that are illustrated in the accompanying drawings and/or detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The present invention discloses a system and method for ultrasound imaging technique by using arbitrary virtual sources of aperture excitation to form the convergence beam at random virtual source positions. The process of excitation of the ultrasound to focus and steer at arbitrary virtual source positions, results in a generated image that shows the enhanced image resolution by reducing imaging artifacts and speeding up the image processing time by fewer nondestructive testing/evaluation (NDT/NDE) measurements.

Furthermore, the proposed technique provides improved image quality, time/cost-effectiveness, and efficiency in generating the image. The proposed method is an alternative to the FMC-TFM method for nondestructive testing/evaluation (NDT/NDE) and analysis of generated images because of the high sensitivity and detectability of the deeper flaws with minimal imaging artifacts of generated images with lesser experimental measurements.

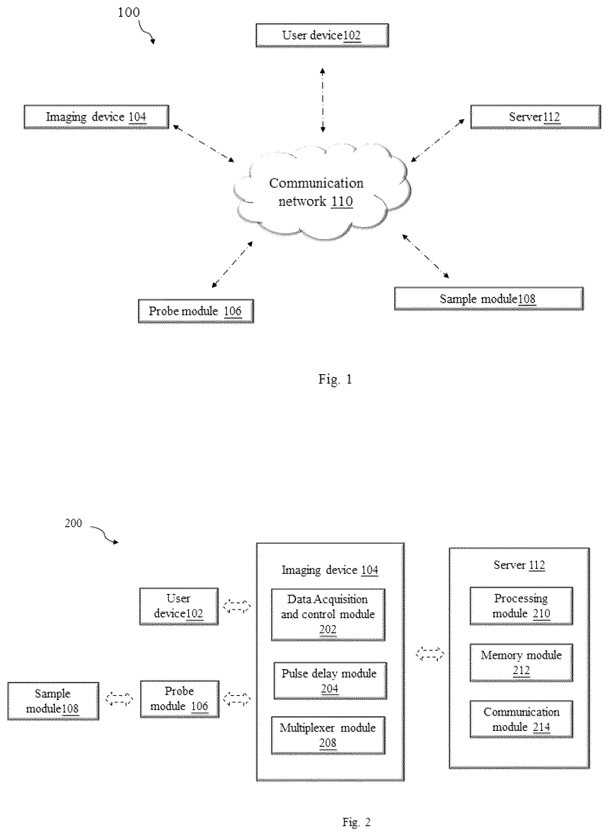

FIG. 1 illustrates details of a system for ultrasound imaging using arbitrary virtual array sources of aperture (AVASA) excitation, in accordance with an embodiment.

The system 100 comprises at least one user device 102, an imaging device 104, a probe module 106, a sample module 108, a communication network 110 and at least one server 112. The imaging device 104 is configured to communicate with the at least one server 112 and/or the user device 102, via the communication network 110.

In an embodiment, the user device 102 is configured to receive one or more input data from the user, wherein the input data comprises at least one of scanning frequency, pitch between transducer element in an array, number of transducer elements in a sub-aperture, and number of virtual sources required for a scanning and scanning area, among others.

In an embodiment, the user devices 102 may comprise one or more of wearable device, mobile phones, PDA, smartphones, smart band, smart watch, laptop, computer, IoT device, etc. The user device 102 may comprise a user application which can control the operations of the system 100.

In an embodiment, the user device 102 comprises one or more hardware, software, and firmware components for receiving, sharing, and displaying data or signals from other devices.

In an embodiment, the imaging device 104 is configured to receive the input data from the user device, to control the functioning of the probe module 106 by using the input data.

In an embodiment, the probe module 106 is configured to trigger multiple transducer elements based a user command from the input data and generate a wave pattern, where the wave will propagate into the sample module 108 for non-destructive testing.

In an embodiment, the sample module 108 comprises one or more sets of specimens to be analyzed.

In an exemplary embodiment depicted in the figures, the sample module 108 comprises at least two sets of specimens, wherein the first set comprises three samples containing different side-drilled holes (SDHs) patterns, and the second set comprises two samples with crack-like defects.

In an embodiment, the communication network 110 can be a wired or a wireless communication network. Wired communication may include LAN, WAN, etc. and wireless communication may include cellular networks, WLAN, wireless sensor networks, etc. A set of standard protocols such as, but not limited to, UART, SPI, I2C, Bluetooth, Wi-Fi, LTE, TCP/IP, HTTP, FTP, UDP, IPV4, IPV6, etc. are used by these communication networks to transfer the data between networks and devices.

In an embodiment, the system 100 may comprise as many servers 112 as required by the users. The servers 112 may comprise one or more cloud server, mobile phones, PDA, smartphones, laptop, computer, etc. The servers 112 may comprise a server application that can monitor and regulate the functions of the system 100.

FIG. 2 illustrates a block diagram depicting working mechanics of multiple units of an ultrasound imaging system using arbitrary virtual array sources of aperture (AVASA) excitation, in accordance with an embodiment of the present disclosure.

In an embodiment, the imaging device 104 comprises a data acquisition and control module 202, a pulse delay module 204, and a multiplexer module 208.

In an embodiment, the data acquisition and control module 202 is configured to gather input data from the user device 102, and control and manage the transducer element based on the received input data.

In an embodiment, the pulse delay module 204 is configured to generate delay pulses. Further, delay law is applied to the receiver transducer elements to make all the elements receive the signals at the same time, and the amplitude of the corresponding time is summed. The process repeats for all the transmission cycles. Thereafter, the delay law is applied to accommodate any time delay during the transmitters and to sum the signal amplitudes.

In an embodiment, the multiplexer module 208 selects and combines multiple input signals into a single output line.

In an embodiment, the server 112 comprises a processing module 210, a memory module 212, and a communication module 214.

In an embodiment, the processing module 210 may comprise one or more of microprocessors, circuits, and other hardware configured for processing. The processing module 210 is configured to execute instructions stored in the memory module 212 as well as communicate with user devices 102 through the input/output module via the communication module 214.

In an embodiment, the memory module 212 of the server 112 comprises one or more volatile and non-volatile memory components which are capable of storing data and instructions to be executed.

In an embodiment, the communication module 214 of the server 112 may include wired and wireless communication, including but not limited to, GPS, GSM, LAN, Wi-fi compatibility, Bluetooth low energy as well as NFC. The wireless communication may further comprise one or more of Bluetooth (registered trademark), ZigBee (registered trademark), a short-range wireless communication such as UWB, a medium-range wireless communication such as WiFi (registered trademark) or a long-range wireless communication such as 3G/4G or WiMAX (registered trademark), according to the usage environment.

In an embodiment, the imaging capability of the arbitrary virtual array source aperture (AVASA) technique is demonstrated by conducting experiments on two sets of test specimens.

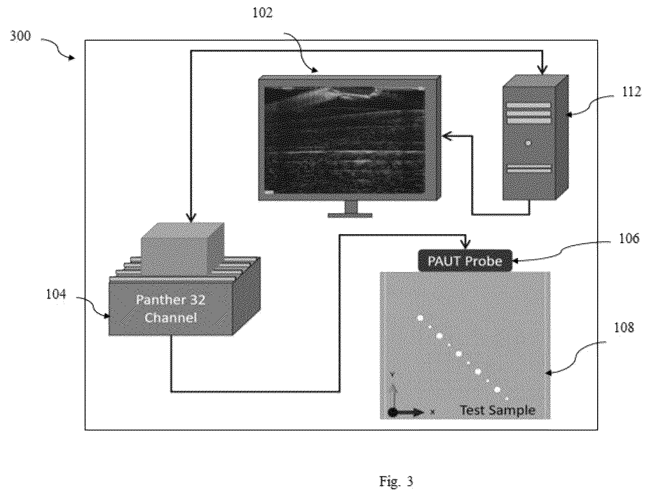

FIG. 3 illustrates schematic block diagram of an experimental setup for inspecting test samples using the imaging device 104, in accordance with an embodiment.

The experimental setup as shown in FIG. 3, comprises:
(1) The imaging device 104 integrated with the server 112.
(2) The linear phased array probe with a central frequency of 5 MHz having 64 elements with a pitch of 0.6 mm.
(3) A steel specimen having one or more artificial defects.

In an embodiment, an ACQUIRE user interface software is installed in the imaging device 104. This software enables the user to feed the test specimen information (dimensions and material properties) and individual scanning technique parameters including but not limited to the number of elements in the active aperture, focusing coordinates.

In an embodiment, one or more transducer elements may be excited by feeding the delay laws and A-scans from all the transducers can be recorded individually in an array.

In an embodiment, during the experiment, a two-cycle Hanning window tone burst signal with a central frequency of 5 MHz is used to excite the ultrasound wave into the medium. The A-scans are recorded with a sampling rate of 125 MHz, and the pulse repetition frequency is set to 0.5 kHz. In the FMC-TFM method, 64 elements are excited one after the other, and corresponding A-scans for each excitation are recorded to form the FMC data.

Similarly, for the VASA and AVASA techniques, each virtual source position is fed into the imaging device 104 for excitation, and corresponding A-scans are recorded to form the FMC data.

A 16-element active aperture was used in the VASA method to emit an ultrasound beam into the medium according to the delay law calculated.

Similarly, in the AVASA technique, a 16-element active aperture was used for excitation with computed delay laws.

The experiments are conducted multiple times with a different combination of the virtual source position to generate ahigh-resolution TFM image in the AVASA method. The entire test specimen area (50×50 mm) was considered for ROI, which is discretized into 500×500 pixels. The TFM algorithm is implemented on the FMC data created from all the techniques (FMC-TFM, VASA, and AVASA) to generate images. The TFM algorithm is developed in MATLAB, and the FMC data is imported to create the TFM image. This process of experimentation was followed for all the specimens to generate the TFM images.

In an embodiment, the TFM images generated using scanning techniques such as FMC-TFM, VASA, and AVASA are quantitatively evaluated using the following metrics: signal-to-noise ratio (SNR), array performance index (API), and image processing time.

Smaller API values indicate higher image resolution and better measuring accuracy. The SNR value also reflects the image quality by comparing an actual defect signal with an average noise level in an image.

A higher resolution of the TFM image shows an excellent SNR value with a lower API value.

$$SNR = 20 * log ( {I}_{max} / {I}_{noise} )$$

Iₘₐₓ is the maximum amplitude in the defect region, and Iₙₒᵢₛₑ is the average amplitude of noise in the TFM image. Similarly, API is calculated for the ratio of the defect area at −6 dB amplitude to the wavelength of scanning frequency.

In an embodiment, the first set of test specimens comprises three samples containing the different side-drilled holes (SDHs) patterns, and the second set consists of the two samples with crack-like defects. These artificial defects are manufactured using electrical discharge machining (EDM). These specimens have 50×50×10 mm dimensions and are made of stainless steel SS316. The FMC-TFM, VASA, and AVASA techniques are used to experiment on these specimens.

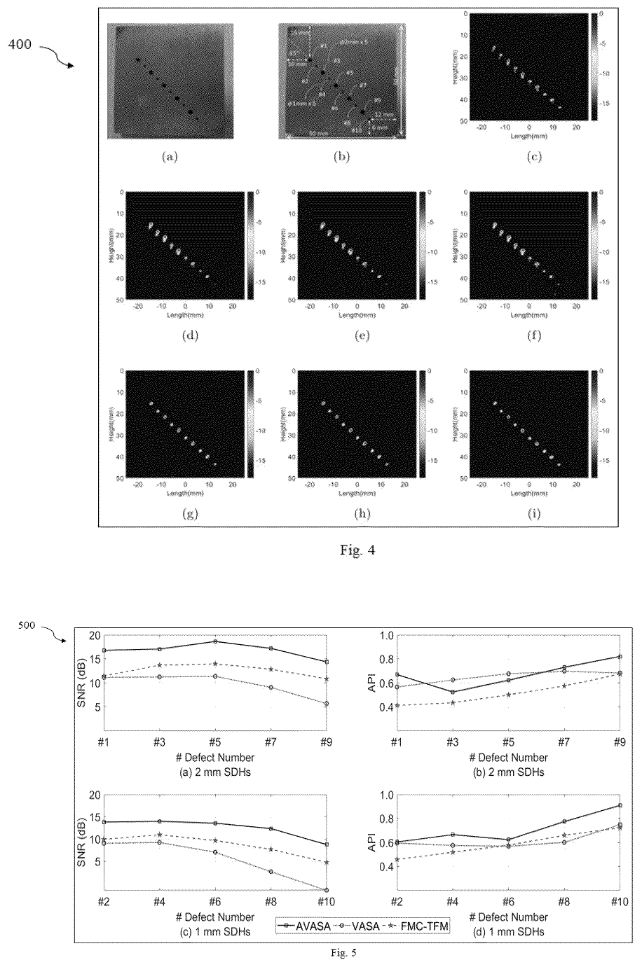

FIG. 4 illustrates experimentally obtained TFM images of side-drilled holes (SDHs) test specimen 1 with various virtual sources of the AVASA technique in comparison with VASA and FMC-TFM, in accordance with an embodiment;

In an embodiment, a first test sample comprises 2 mm and 1 mm SDHs arranged alternatively in a linear pattern aligned at an angle of 45 degrees. The specimen dimension and defect numbering are shown in FIG. 4(a)-(b). These defects are sequentially numbered from #1 to #10. This specimen with a linear pattern of SDHs is considered for experimentation to evaluate the following using three scanning techniques: (1) imaging sensitivity for detecting discontinuities with varying sizes, and (2) the SNR values of defects located at varying depths from the transducer location.

The experimentally obtained FMC-TFM with the 64-element image is shown in FIG. 4(c) of the first test specimen. Similarly, the image generated by varying numbers of virtual sources (5, 8, and 16) using the VASA and AVASA method is shown in FIG. 4(d)-(f) and in FIG. 4(g)-(i), respectively. These images reflect the original test sample geometry regarding defect shape, size, and location.

Advantageously, compared to the FMC-TFM and VASA generated images, the AVASA technique provides better image resolution, higher defect intensity, and fewer artifacts around the defects.

As the number of virtual sources increases, artifacts near the defects increase in VASA images in comparison with AVASA images.

Advantageously, the AVASA images have minimal artifacts for the following reasons:
(1) No two virtual source positions are in the same phase while applying the TFM algorithm, which reduces the noise level in the image; and
(2) To obtain unique virtual source positions, Poisson distribution is used.

However, in the FMC-TFM technique, the transducer array elements are excited from the constant vertical positions, and the emitted ultrasound beams are in the same phase. Even in the VASA technique, all the virtual sources are in the same phase because of the constant focal distance from the transducer array. Hence, disadvantageously, the signals from the defects and noise from other locations create the principle of constructive interference, eventually showing the additional artifacts.

In an embodiment, for test specimen 1, the SNR and API values are calculated for defect #5 in each TFM image from FIG. 4(c)-(i) to quantitatively compare three scanning techniques. The image reconstruction time for VASA and AVASA is computed for each virtual source TFM image and compared with FMC-TFM and the experimentation details are given below in Table 1.

TABLE 1
The SNR and API values are calculated for defect #5 in each TFM image
from FIG. 4(c)-(i) to quantitatively compare three scanning techniques.

| | | | TFM image | AVASA | | VASA | | FMC-TFM | |
|---|---|---|---|---|---|---|---|---|---|
| Scanning | Active | Virtual | reconstruction | SNR | | SNR | | SNR | |
| Technique | Aperture | sources | Time (s) | (dB) | API | (dB) | API | (dB) | API |
| AVASA/ | 16 | 5 | 16 | 21.3 | 0.66 | 11.9 | 0.68 | — | — |
| VSA | elements | 8 | 22 | 18.6 | 0.62 | 11.3 | 0.68 | — | — |
| | | 16 | 37 | 19.1 | 0.60 | 13.9 | 0.66 | — | — |
| FMC | 1 | — | 130 | — | — | — | — | 13.9 | 0.72 |

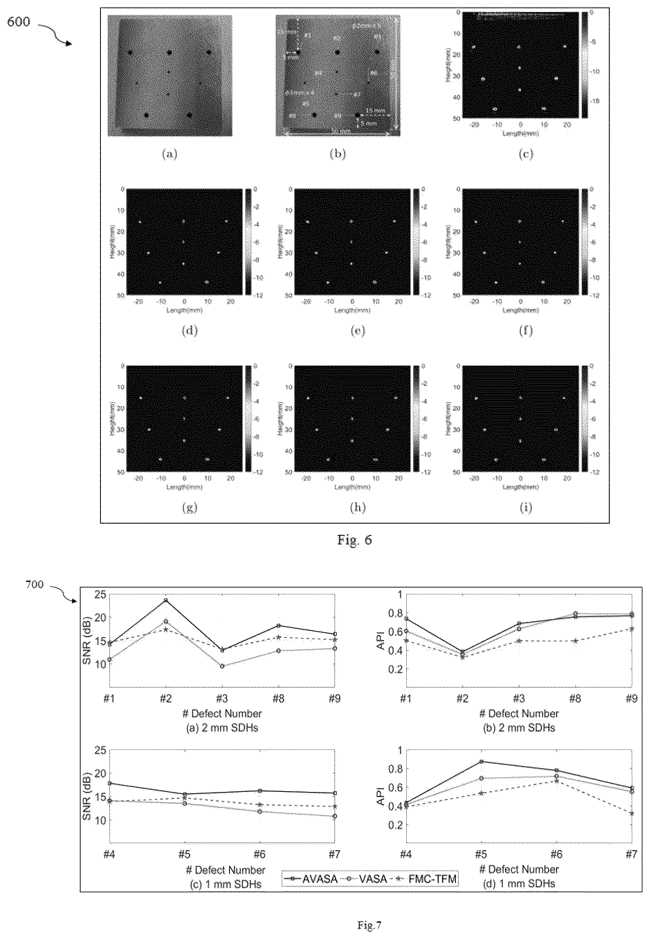

FIG. 5 illustrates quantitative evaluation for the test specimen 1, in accordance with an embodiment of the present disclosure.

The TFM image generated using the 5-virtual source of AVASA is compared with 5-virtual source of VASA, and FMC-TFM is quantitatively assessed using SNR and API.

In FIG. 5, (a) depicts SNR for 2 mm SDHs, (b) depicts API values for 2 mm SDHs, (c) depicts SNR values for 1 mm SDHs, and (d) depicts API values for 1 mm SDHs.

Further observations from FIG. 5 are as follows:
(1) The SNR is higher for defects below the center of the transducer elements than the defects present at extreme ends.
(2) Considering SDHs of 2 mm diameter (#1, #3, #5, #7, and #9), SNR gradually increases till #5 and then decreases, as shown in FIG. 5(a). A similar performance is observed for 1 mm SDHs in FIG. 5(c).
(3) The flaws present at higher depth are less sensitive and have poor image resolution because of attenuation.
(4) In the AVASA technique, the SNR for deeper defects is improved than FMC-TFM and VASA due to weakening noise levels in the image because of constructive interference of defect signals and destructive interference of noise signals since virtual sources are randomly located.
(5) The API values for defects located directly below the center of the transducer are lower than those found at extremes, refer to FIGS. 5(b) and (d).
(6) The API values for each defect are better in the FMC-TFM because the 64 excitations contribute to reconstruction of the defect shape.

In an embodiment, the SNR, API, and image processing time for quantitative evaluation of FMC-TFM, VASA, and AVASA techniques were computed. The defect #5 in the TFM images in FIG. 5(c)-(i) has higher intensity values (i.e., 0 dB), so this defect is chosen for computing the evaluation metrics. Table 1 reports the computed SNR and corresponding API values for the defect #5 in the test specimen by varying virtual sources (5, 8, and 16) for the proposed techniques and 64 elements of the FMC-TFM techniques.

Further observations from Table 1 are as follows:
(1) The SNR values from the VASA and AVASA are more significant than the FMC-TFM.
(2) As the number of the virtual sources increase, the noise level in the image increases, therefore, the SNR value decreases for an image in the AVASA technique.
(3) With increasing the number of virtual sources, the API value is better (i.e., decreasing trend) because the ultrasound beam interaction with the defect is higher. In the AVASA technique, the API value is slightly higher compared to other techniques because the ultrasound beam is exciting with random virtual source positions. Hence, the ultrasound beam interacts with the defect in all possible orientations.
(4) The TFM image generation time is high for the FMC-TFM method than for the VASA and AVASA with varying virtual sources.

Further, the SNR and API values of the 5-virtual source TFM image of the AVASA show a significant improvement over the VASA and FMC-TFM, and the computational time to reconstruct the TFM image is 16 seconds, which is 8.15 times faster than the FMC-TFM, and significantly reduces data acquisition during experimentation. Therefore, the AVASA-generated image with a 5-virtual source is considered for detailed analysis of each defect by computing SNR and API. These quantitative values are compared with the FMC-TFM and VASA-generated image with the 5-virtual source.

Advantageously, the AVASA technique TFM image generated with a 5-virtual source is 8.15 times faster, and the FMC data required for the TFM image reconstruction is 13 times less than the 64-element FMC-TFM method.

Further, an added advantage is that overall, the image from AVASA has better SNR and comparable API with an adequate defect size than the FMC-TFM and VASA techniques.

FIG. 6 illustrates AVASA images generated with the varying virtual sources are compared with VASA and FMC-TFM for test specimen 2, in accordance with an embodiment of the present disclosure.

In an embodiment, the second test sample comprises of the 2 mm, and 1 mm SDHs spread all over the area of the specimen. The physical dimension of the specimen is illustrated in FIG. 6(a)-(b). These SDHs are numbered sequentially from #1 to #9. This sample is used for imaging to assess the scanning sensitivity of the techniques by masking a few SDHs below the shadow of the other SDHs, and a few are offsetting to each of the one or more transducer elements diameter. The defect near each of the one or more transducer elements position could obstruct the ultrasound beam for imaging the flaws located far from the transducer, resulting in low-resolution TFM image.

In an embodiment, a second test sample using the three scanning techniques to evaluate the qualitative TFM image generation. This test sample contains the spread of SDHs with 2 mm and 1 mm diameters, as shown in FIG. 6(a)-(b).

The experimentally obtained TFM image from the FMC-TFM technique is shown in FIG. 6(c), and images generated using VASA and AVASA with varying numbers of virtual sources (5, 10, and 16) are shown in FIG. 6(d)-(f), and FIG. 6(g)-(i), respectively.

In the AVASA technique, images have a better indication of defect shape and distinguishability between 2 mm and 1 mm diameters except for extremely located defects, which are #5, and #6. The TFM images generated for varying virtual sources using the AVASA technique have a higher image resolution and lesser imaging artifacts compared to images generated using other techniques. With the increasing number of virtual sources excitation, the intensity of each defect increases, as well as imaging artifacts near the defects also increase.

The SNR and API values are calculated for defect #2 in each TFM image from FIG. 6(c)-(i) to quantitatively compare three scanning techniques. The experimentation details are given in table 2 below.

TABLE 2
The SNR and API values are calculated for defect #2 in each TFM image
from FIG. 6(c)-(i) to quantitatively compare three scanning techniques

| | | | TFM image | AVASA | | VASA | | FMC-TFM | |
|---|---|---|---|---|---|---|---|---|---|
| Scanning | Active | Virtual | reconstruction | SNR | | SNR | | SNR | |
| technique | aperture | source | Time (s) | (dB) | API | (dB) | API | (dB) | API |
| AVASA/ | 16 | 5 | 16 | 23.6 | 0.38 | 19.1 | 0.35 | — | — |
| VSA | elements | 10 | 27 | 19.5 | 0.36 | 18.4 | 0.33 | — | — |
| | | 16 | 37 | 19.0 | 0.33 | 18.6 | 0.32 | — | — |
| FMC | 1 | — | 130 | — | — | — | — | 17.3 | 0.32 |

The observation from FIG. 6(c)-(i) is that the TFM images generated from three techniques show higher intensity for the defects located at the center of the transducer array than at extremes. Therefore, defect #2 was considered for calculating SNR and API as it is located directly below the transducer array and has the maximum intensity among all the defects.

Table 2 shows the SNR and API of the proposed method for varying virtual sources and 64-elements FMC-TFM. The observation from Table 2 is as follows:
(1) the SNR values are decreasing as the number of virtual sources increases because of the increasing noise level in the image.
(2) The API value is decreasing with an increasing number of virtual sources because of more ultrasound beam excitation.
(3) The SNR and API values from the VASA and AVASA techniques closely match the FMC-TFM-generated image for #2.

FIG. 7 illustrates quantitative evaluation for the test specimen 2, in accordance with an embodiment of the present disclosure.

FIG. 7 illustrates quantitative evaluation for the test specimen 2, wherein the AVASA image generated with a 5-virtual source is compared with the VASA image with a 5-virtual source and FMC-TFM image.

In FIG. 7, (a) depicts SNR for 2 mm SDHs, (b) depicts API values for 2 mm SDHs, (c) depicts SNR values for 1 mm SDHs, and (d) depicts API values for 1 mm SDHs.

In an embodiment, the image generated with the AVASA using the 5-virtual source has the best SNR and API among all other TFM images. So, the SNR and API of the 5-virtual source AVASA image are quantitatively compared with the VASA image with 5-virtual sources and the FMC-TFM image. The computed SNR and API values for 1 mm and 2 mm diameter SDHs are shown in FIG. 7.

As listed below, notable observations from FIG. 7 are provided below: (1) In the AVASA technique, the SNR values for the 2 mm and 1 mm defects are significantly higher among all the methods.
(2) The SDHs (#1 and #3) located far from the center of the transducer array have lesser SNR due to lesser interaction of the incident ultrasound.
(3) In the FMC-TFM technique, API for 2 mm and 1 mm SDHs is better than other proposed methods because the defect size at −6 dB is smaller due to the unfocused beam transmitted into the medium.
(4) From all three techniques, the API values for defects #4 and #7 are higher than other 1 mm SDHs because these defects are under the shadow of the 2 mm defects, which obstruct the path of the ultrasound beam.
(5) The 2 mm SDHs imaging with AVASA is comparable to the actual defect size. The 1 mm SDHs imaging with the FMC-TFM method is close to the actual defect size because of the maximum time the ultrasound beam interacts with the defects, which eventually helps to create a better defect shape than a fewer number of excitations.

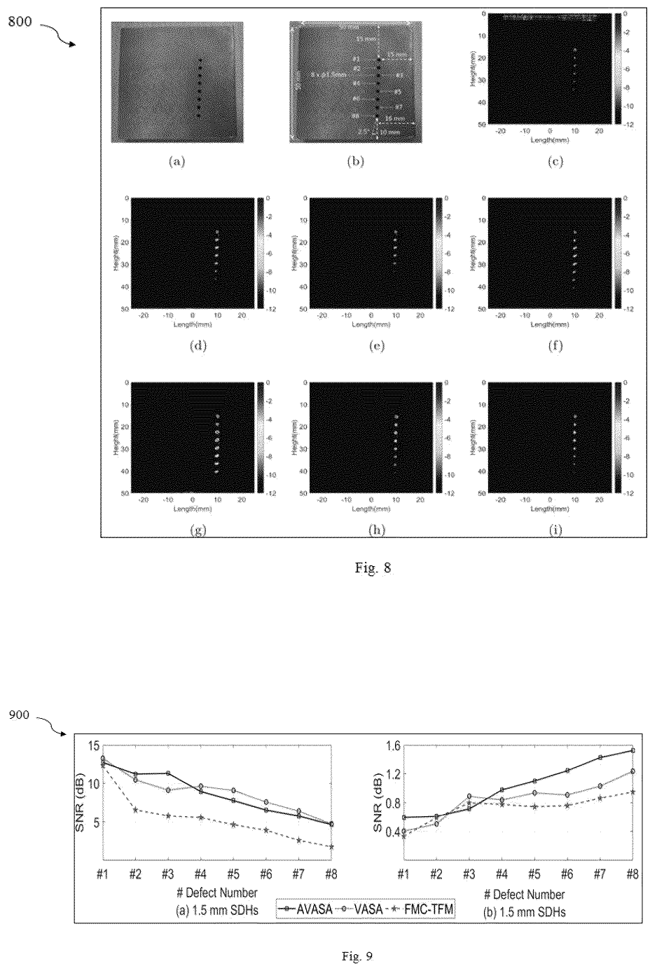

FIG. 8 illustrates the experimental results of the TFM images with various virtual sources and FMC-TFM for test specimen 3, in accordance with an embodiment of the present disclosure.

In an embodiment, the third test sample has 8 SDHs of diameter 1.5 mm in a linear pattern aligned with a 2.5 degrees inclination to the vertical axis to evaluate the defect resolution and sizing. These defects are sequentially numbered from #1 to #8, as shown in FIG. 8(a).

In an embodiment, the third test specimen has SDHs of 1.5 mm diameters and is aligned vertically downwards with an inclination of 2.5 degrees and used for evaluating the axial and lateral resolution, as shown in FIG. 8(a)-(b).

The FMC-TFM generated image is shown in FIG. 8(c), and VASA and AVASA technique images with various virtual sources (6, 8, and 16) are demonstrated in FIG. 8(d)-(f), and FIG. 8(g)-(i), respectively. The images generated from the AVASA are comparatively better among the methods in terms the defect intensity and shapes and have lesser imaging artifacts next to the defects. Especially the bottom defects signal is significant and could be seen in the AVASA-generated TFM images because the ultrasound beam is steered and focused at the random position of the virtual source. However, in the VASA technique, the bottom SDHs have a lower defect signal because the ultrasound beam is emitted normally to the defect surface, and the top SDHs mask the bottom SDHs. Therefore, the defect shape and size are deteriorating with depth.

In an embodiment, the #1 defect has the maximum intensity in all the TFM images produced from three techniques. The SNR and API for the #1 in the TFM images generated by VASA and AVASA using various virtual sources and the FMC-TFM was calculated, which is reported in Table 3. As the number of virtual sources increases, SNR values decrease due to increased noise in the image, and API reduces because of the multiple transmission of the ultrasound beam into the medium.

The SNR and API values are calculated for defect #1 in each TFM image from FIG. 8(c)-(i) to quantitatively compare three scanning techniques.

TABLE 3
The SNR and API values are calculated for defect #1 in each TFM image
from FIG. 8(c)-(i) to quantitatively compare three scanning techniques.

| | | | TFM image | AVASA | | VASA | | FMC-TFM | |
|---|---|---|---|---|---|---|---|---|---|
| Scanning | Active | Virtual | reconstruction | SNR | | SNR | | SNR | |
| Technique | Aperture | sources | Time (s) | (dB) | API | (dB) | API | (dB) | API |
| AVASA/ | 16 | 6 | 22 | 11.6 | 0.64 | 12.2 | 0.47 | — | — |
| VSA | elements | 8 | 18 | 13.8 | 0.55 | 13.7 | 0.48 | — | — |
| | | 16 | 37 | 12.7 | 0.59 | 13.2 | 0.40 | — | — |
| FMC | 1 | — | 130 | — | — | — | — | 12.3 | 0.33 |

FIG. 9 illustrates quantitative evaluation for the test specimen 3, in accordance with an embodiment of the present disclosure;

The AVASA-generated image with the 8-virtual source has the best SNR and API among all other TFM images, which is considered for further analysis to evaluate SNR, API, and size of each defect and compared quantitatively with VASA and FMC-TFM. FIG. 9 shows the computed SNR and API values. In the AVASA, the SNR values for each defect are similar to VASA but higher than the FMC-TFM. SNR decreases with increasing SDHs depth due to the attenuation of the ultrasound. The API values are identical to the VASA and AVASA but higher than the FMC-TFM method.

As the depth of the SDHs increases, API values increase due to the poor image resolution, but AVASA shows higher values due to the strong defect indications. The defect located at the bottom of the specimen has a greater defect size, because of the poor sensitivity. Because of the close proximity of SDHs in the sample, the artifacts and noise increase as the number of virtual sources increases.

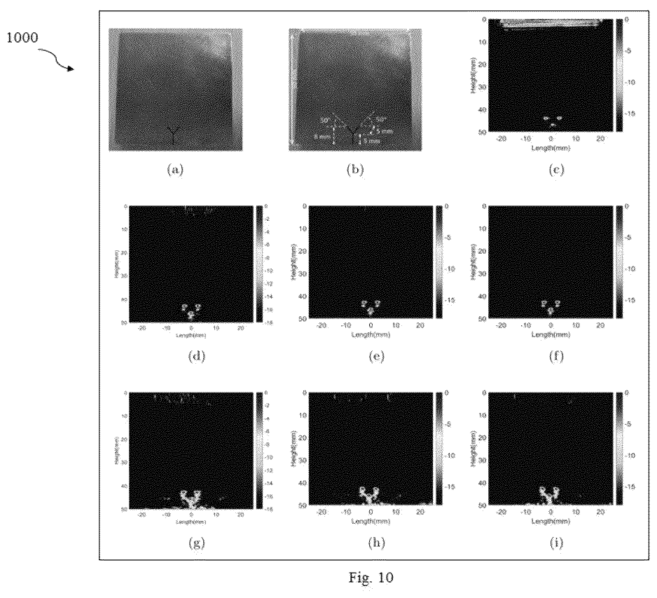

FIG. 10 illustrates images generated using the TFM algorithm during post processing with FMC-TFM, VASA, and AVASA techniques with various virtual sources for ‘Y’ shaped crack, in accordance with an embodiment of the present disclosure;

In an embodiment, the fourth test sample comprises a ‘Y’ shaped crack at the bottom, as shown in FIG. 10(a)-(b). To resemble a weld root crack, the fourth test sample/specimen was considered. This defective sample was used to evaluate the sensitivity of generating the complete profile indication.

In the second set of samples, the test specimen comprises a ‘Y’ shaped crack to imitate the weld root crack to demonstrate the imaging capability of the proposed technique to intricate definitions. The TFM images produced from three scanning methods are shown in FIG. 10 for ‘Y’ shaped crack. In particular, FIG. 10(c) show the FMC-TFM technique generated images for ‘Y’ shaped cracks. In general, the observation from the FMC-TFM method of crack imaging shows only the tip of the cracks that gives the relevant indications. No other representations are visible in the TFM images. Similarly, the images generated with the varying virtual sources of the VASA technique are reported in FIG. 10(d)-(f). These experimental images show higher signal amplitude at the crack tip and the additional artifacts near the crack tip.

The maximum SNR values calculated on the tip of the ‘Y’ shaped crack of TFM images in FIG. 10(c)-(i) and compared quantitatively for AVASA, VASA, and FMC-TFM are disclosed in Table 4.

TABLE 4
The maximum SNR values calculated on the tip of the ‘Y’
shaped crack of TFM images in FIG. 10(c)-(i) and compared
quantitatively for AVASA, VASA, and FMC-TFM.

| | | | TFM image | AVASA | VASA | FMC-TFM |
|---|---|---|---|---|---|---|
| Scanning | Active | Virtual | reconstruction | SNR | SNR | SNR |
| Technique | Aperture | sources | Time (s) | (dB) | (dB) | (dB) |
| AVASA/ | 16 | 16 | 22 | 27.7 | 30.4 | — |
| VSA | elements | 32 | 72 | 29.3 | 32.5 | — |
| | | 49 | 106 | 29.6 | 32.8 | — |
| FMC | 1 | — | 130 | — | — | 20.7 |

FIG. 10(g)-(i) shows the TFM images for varying virtual sources for AVASA imaging for the ‘Y’ shape crack, and the definition of the ‘Y’ crack indication is visible. These indications are not artifacts because they are continuous signals from the crack profile. However, some noise is present throughout the TFM images due to secondary sound wave reflections from the crack. As the number of virtual sources increases, the defect indication significantly improves.

In the AVASA-generated images with various virtual sources for ‘Y’ shaped cracks, the complete crack profile imaging is possible due to the ultrasound beam being steered and focused at random virtual source positions.

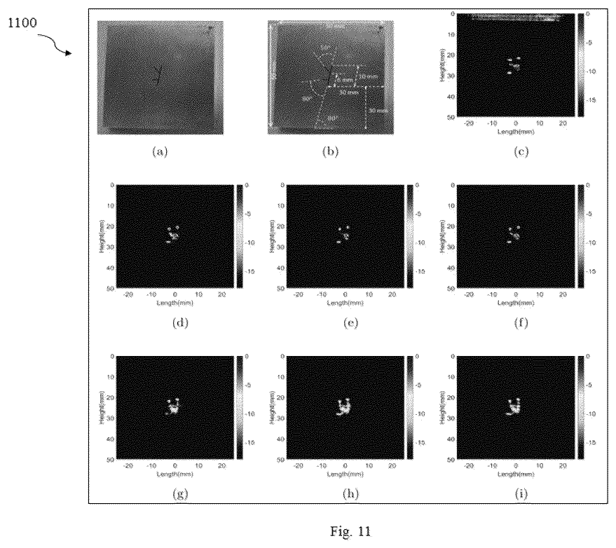

FIG. 11 illustrates experimental results of the TFM images with various virtual sources of the VASA and AVASA and FMC-TFM for inclined ‘PI’ shaped crack, in accordance with an embodiment;

In an embodiment, the fifth test sample has a crack in the shape of an inclined ‘PI’ located at the center, shown in FIG. 11(a)-(b). This test sample evaluates the proposed scanning capability of the crack profile indication methods.

In the second set of samples, the test specimen comprises an inclined ‘PI’ shaped crack at the center to demonstrate the imaging capability of the proposed technique to intricate definitions. The TFM images produced from three scanning methods are shown in FIG. 11 for the inclined ‘P’ shaped crack. In particular, FIG. 11(c) shows the FMC-TFM technique generated images for inclined ‘PI’ shaped crack. In general, the observation from the FMC-TFM method of crack imaging shows only the tip of the cracks that gives relevant indications. No other representations are visible in the TFM images. Similarly, the images generated with varying virtual sources of the VASA technique are reported in FIG. 11(d)-(f). These experimental images show higher signal amplitude at the crack tip and the additional artifacts near the crack tip.

The maximum SNR values calculated on the tip of the inclined ‘PI’ shaped crack of TFM images in FIG. 11(c)-(i) and compared quantitatively for AVASA, VASA, and FMC-TFM is disclosed below in Table 5.

TABLE 5
The maximum SNR values calculated on the tip of the ‘Y’
shaped crack of TFM images in FIG. 11(c)-(i) and compared
quantitatively for AVASA, VASA, and FMC-TFM.

| | | | TFM image | AVASA | VASA | FMC-TFM |
|---|---|---|---|---|---|---|
| Scanning | Active | Virtual | reconstruction | SNR | SNR | SNR |
| Technique | Aperture | sources | Time (s) | (dB) | (dB) | (dB) |
| AVASA/ | 16 | 16 | 22 | 31.4 | 34.8 | — |
| VSA | elements | 32 | 72 | 30.9 | 37.5 | — |
| | | 49 | 106 | 32 | 37.3 | — |
| FMC | 1 | — | 130 | — | — | 28.9 |

The TFM images generated using AVASA using varying virtual sources for the inclined ‘PI’ shaped crack are shown in FIG. 11(g)-(i). Almost all inclined ‘PI’ shaped crack branch definitions are visible, except the bottom branch of the crack is not visible because the adjacent upper limb masks it. As the number of virtual sources increases, the defect indication significantly improves. In the AVASA-generated images with various virtual sources for inclined ‘PI’ shaped cracks, the complete crack profile imaging is possible due to the ultrasound beam being steered and focused at random virtual source positions.

The TFM images generated using three techniques are qualitatively assessed by computing the SNR and image processing time. The SNR values are calculated by taking the maximum amplitude from one of the crack tips from ‘Y’ and inclined ‘PI’ crack specimens. The summary of calculated SNR values of the AVASA and VASA for varying virtual sources and FMC-TFM is reported in Table 4 for ‘Y’ and Table 5 for inclined ‘PI’ crack. As the number of virtual sources increases, the SNR values for crack-shaped defects also increase. SNR values for AVASA are relatively close to VASA but higher than the FMC-TFM. Even though there is some low amplitude noise level in the TFM image, the AVASA technique gave significantly good defect SNR and quality TFM image with crack profile indication.

Due to the intricate shape, the sample with an inclined ‘PI’ shaped crack at the center is quite difficult to imagine. Besides the bottom branch (masked by an adjacent upper limb of the defect), the rest of the crack profile is visible in the TFM image. The fewer triggering of the virtual sources gives a complete crack profile in the AVASA than the FMC-TFM method; as a result, it reduces the processing data for generating the image and improves the image sensitivity.

In an embodiment, the phased array ultrasonic testing (PAUT) equipment is used to scan all the steel test specimens containing artificial defects. The A-scan signals are acquired to validate the algorithms.

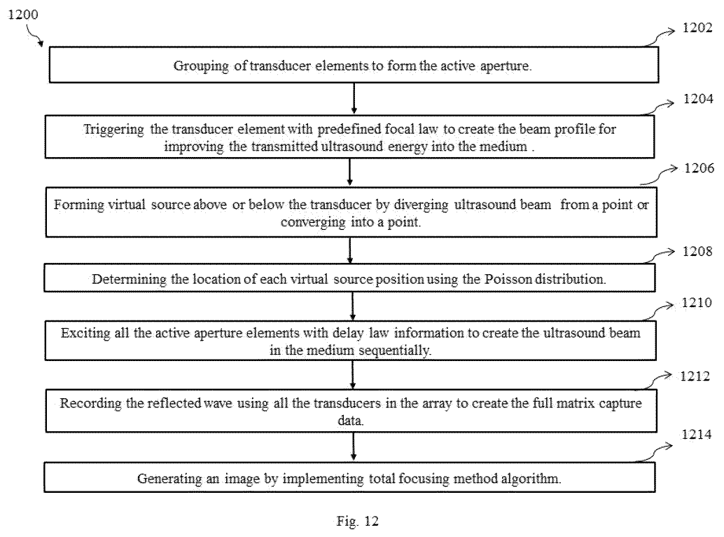

FIG. 12 illustrates a flowchart depicting the method for ultrasound imaging using arbitrary virtual array sources of aperture (AVASA) excitation, in accordance with an embodiment of the present disclosure.

The method begins with grouping of transducer elements to form the active aperture, as depicted in step 1202. Subsequently, the method 1200 discloses triggering the transducer element with predefined focal law to create the beam profile for improving the transmitted ultrasound energy into the medium, as depicted in step 1204. Thereafter, the method 1200 discloses forming virtual source above or below the transducer by diverging ultrasound beam from a point or converging into a point, as depicted in step 1206. Subsequently, the method 1200 discloses determining the location of each virtual source position using the Poisson distribution, as depicted in step 1208.

Thereafter, the method 1200 discloses exciting all the active aperture elements with delay law information to create the ultrasound beam in the medium sequentially, as depicted in step 1210. Subsequently, the method 1200 discloses recording the reflected wave using all the transducers in the array to create the full matrix capture data, as depicted in step 1212. Thereafter, the method 1200 discloses generating an image by implementing total focusing method algorithm, as depicted in step 1214.

The advantages of the current invention include enhanced SNR by increasing transmitting energy and improving the image resolution by reducing the artifacts along with a reduction in overall computation time.

An additional advantage is that the proposed invention could generate imaging with fewer virtual source excitations by reducing the image processing time and improving image quality than classical FMC-TFM.

Furthermore, the images generated using the AVASA technique have minimal artifacts near the defect since no two virtual sources are in the same phase. So, while applying the TFM algorithm, signals from the defects will form the constructive interference, and the remaining locations will create the destructive interference. Hence, the proposed method significantly improves imaging performance and reduces inspection and data processing time. Therefore, this method can be potentially applied to the real-time assessment of the thicker samples, weld inspections, and dual-layer media in nondestructive evaluation.

Applications of the current invention include ultrasound imaging and non-destructive evaluation.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described here.

We claim:

1. A system (100) for ultrasound imaging of a test sample by using arbitrary virtual array sources (AVASA) of excitation, comprising:
an imaging device (104) comprising:
a data acquisition and control module (202) configured to receive at least one input data, and activate and control one or more transducer elements based on the received input data;
a transducer array comprising multiple transducer elements;
multiple arbitrary virtual array source apertures (AVASA);
a pulse delay module (204) configured to generate and apply one or more delay pulses to at least one activated transducer element;
at least one ultrasound beam transmitted from the at least one activated transducer element into at least one sample module (108);
at least one reflected ultrasound beam from the sample module (108) received and recorded by all transducer elements in the transducer array to create a full matrix capture (FMC) data, wherein a total focusing method (TFM) algorithm is implemented to generate an image; and
a multiplexer module (208) configured to select and combine multiple input ultrasound beam signals into a single output line.

2. The system (100) as claimed in claim 1, comprising:
at least one user device (102) configured to receive at least one input data from a user and communicate the input data to the data acquisition and control module (202);
a probe module (106) configured to trigger the at least one transducer element based on the input data to generate a wave pattern, wherein the generated wave pattern is transmitted into the sample module (108) by the at least one transducer elements, and wherein the probe module (106) is configured to receive the reflected ultrasound beam from the sample module (108);
a sample module (108) comprising at least one test sample; and
at least one server (112) comprising a server application for monitoring and regulating functions of the system (100).

3. The system (100) as claimed in claim 1, wherein the multiplexer module (208) is configured to select and combine multiple delays which are further applied to the ultrasound beams transmitted from the imaging device (104) to a probe module (106) and to the ultrasound beams reflected and received at the imaging device (104) from the probe module (106).

4. The system (100) as claimed in claim 1, wherein the input data comprises at least one of: scanning frequency, pitch between transducer elements in the array, number of transducer elements in sub-aperture, and number of virtual sources required for scanning and scanning area.

5. The system (100) as claimed in claim 1, wherein the multiple transducer elements are grouped to form at least one active aperture element, wherein the at least one active aperture element is triggered by using at least one predefined focal law to create a beam profile for improving energy of the ultrasound beam transmitted into the sample module (108).

6. The system (100) as claimed in claim 5, wherein the one or more active aperture elements are excited with delay law information to create and transmit the ultrasound beam in the sample module (108) sequentially.

7. The system (100) as claimed in claim 1, comprising multiple arbitrary virtual array source apertures (AVASA) placed below the transducer array, and wherein location of each virtual source is determined by using a discrete probability distribution.

8. The system (100) as claimed in claim 6, wherein the ultrasound beam reflected from the sample module (108) is received and recorded to create a full matrix capture (FMC) signal data, and wherein the ultrasound image is generated by implementing total focusing method algorithm.

9. The system (100) as claimed in claim 7, wherein the ultrasound image is generated by triggering fewer arbitrary virtual array source aperture excitations in the sample module (108) than Full Matrix Capture (FMC)-Total Focusing Method (TFM), to reduce inspection time.

10. The system (100) as claimed in claim 1, wherein the system (100) using arbitrary virtual array source aperture (AVASA) is configured to receive and form a constructive interference phenomenon of defect signals and form a destructive interference phenomenon of noise signals.

11. A method (1200) for ultrasound imaging by using arbitrary virtual array sources of aperture (AVASA) of excitation, comprising:
receiving at least one input data, and activating and controlling one or more transducer elements based on the received input data;
generating and applying one or more delay pulses to at least one activated transducer element from a transducer array comprising multiple transducer elements;
transmitting at least one ultrasound beam from the at least one activated transducer element into at least one sample module (108);
receiving and recording at least one reflected ultrasound beam from the sample module (108), by all transducer elements in the transducer array to create a full matrix capture (FMC) data,
implementing a total focusing method (TFM) algorithm to generate an image; and
selecting and combining multiple input ultrasound beam signals into a single output line.

12. The method (1200) as claimed in claim 11, comprising:
receiving at least one input data from a user and communicate the input data to a data acquisition and control module (202), by at least one user device (102);
triggering the at least one transducer element based on the input data to generate a wave pattern, comprising transmitting the generated wave pattern by the at least one transducer elements, and receiving the reflected ultrasound beam;
monitoring and regulating functions of the method (1200) by at least one server (112) comprising a server application.

13. The method (1200) as claimed in claim 11, comprising selecting and combining multiple delays which are further applied to the ultrasound beams transmitted from the imaging device (104) to a probe module (106) and to the ultrasound beams reflected and received at the imaging device (104) from the probe module (106).

14. The method (1200) as claimed in claim 11, comprising receiving at least one input data comprising at least one of: scanning frequency, pitch between transducer elements in the array, number of transducer elements in sub-aperture, and number of virtual sources required for scanning and scanning area.

15. The method (1200) as claimed in claim 11, comprising grouping the multiple transducer elements to form at least one active aperture element, and triggering the at least one active aperture element by using at least one predefined focal law to create a beam profile for improving energy of the transmitted ultrasound beam.

16. The method (1200) as claimed in claim 11, comprising exciting the one or more active aperture elements with delay law information to create and transmit the ultrasound beam sequentially.

17. The method (1200) as claimed in claim 11, comprising placing multiple arbitrary virtual array source apertures (AVASA) below the transducer array, and determining location of each virtual source by using a discrete probability distribution.

18. The method (1200) as claimed in claim 11, comprising receiving and recording the reflected ultrasound beam to create a full matrix capture (FMC) signal data, and generating the ultrasound image by implementing total focusing method algorithm.

19. The method (1200) as claimed in claim 11, comprising generating the ultrasound image by triggering fewer arbitrary virtual array source aperture excitations in the sample module (108) than Full Matrix Capture (FMC)-Total Focusing Method (TFM), to reduce inspection time.

20. The method (1200) as claimed in claim 11, comprising using the method (1200) comprising arbitrary virtual array source apertures (AVASA) to receive and form a constructive interference phenomenon of defect signals and form a destructive interference phenomenon of noise signals.
